(19) United States
(12) Patent Application Publication
(10) Pub. No.: US 2013/0177122 A1
(43) Pub. Date: Jul. 11, 2013

(54) Reactor Water-Level/Temperature Measurement Apparatus

(71) Applicant: Hitachi-GE Nuclear Energy, Ltd., Hitachi-shi (JP)

(72) Inventors: Atsushi FUSHIMI, Hitachi (JP); Atsushi BABA, Tokai (JP); Izumi YAMADA, Tokai (JP); Setsuo ARITA, Hitachiota (JP); Masaki KANADA, Hitachi (JP); Akira MURATA, Hitachi (JP); Tamotsu ASANO, Hitachi (JP); Mikio KOYAMA, Hitachi (JP); Hiroaki KATSUYAMA, Hitachi (JP); Ryuta HAMA, Hitachi (JP); Itsuki NAITO, Hitachi (JP)

(73) Assignee: HITACHI-GE NUCLEAR ENERGY, LTD., Hitachi-shi (JP)

(21) Appl. No.: 13/727,374

(22) Filed: Dec. 26, 2012

(30) Foreign Application Priority Data
Jan. 5, 2012 (JP) 2012-000821

(51) Int. Cl. G21C 17/035

(52) U.S. Cl. CPC G21C 17/035
USPC 376/247

(57) ABSTRACT

A reactor water-level/temperature measurement apparatus is disclosed that includes an in-core instrumentation tube inserted into an in-core instrumentation housing and an in-core instrumentation guide tube, a plurality of water-level/temperature detection sensors provided in the tube, a temperature measurement device measuring the temperature of a thermocouple included in each of the sensors, a heater control device for controlling a current flowing to a heater wire included in each of the sensors, a storage device used for storing a threshold-value table, and a water atmosphere and a sensor failure and a water-level/temperature/failure determination device.

### BACKGROUND OF THE INVENTION

1. Field of the Invention

The present invention relates to a water-level/temperature measurement apparatus for measuring water levels and temperatures in a nuclear reactor.

2. Description of the Related Art

In a boiling-water reactor, reactor water is evaporated in a nuclear reactor by heat generated from a fuel in order to produce steam and the produced steam rotates a turbine in order to generate electric power. Thus, in the upper part of the core of the reactor, a reactor water level also referred to hereafter simply as a water level is established. The reactor water level is a boundary between the reactor water and the steam. The reactor water level is controlled to a proper position in order to assure the performance of a separator and the performance of a dryer. The separator is means for separating the steam and the reactor water from each other. In addition, there is provided a mechanism for monitoring the reactor water level in order to prevent the heat removal from becoming insufficient due to the reactor core being exposed out off the reactor water and, if necessary, for activating an emergency core cooling system in the event of a loss of coolant accident.

In the conventional boiling-water reactor, the reactor water level is measured on the basis of a differential pressure signal output by a differential pressure transmitter provided outside the reactor to serve as a transmitter to which an instrumentation tube applies a pressure coming from a reference-height water pole and a pressure according to a water level in the reactor. Depending on applications, there are a plurality of types of the differential pressure transmitter and the instrumentation tube which are used in the measurement. For example, in order to sustain the high performance to separate the reactor water and the steam from each other, there is provided a normal-operation water-level meter for monitoring a narrow range with a high degree of precision. In addition, there is also provided a water-level meter covering a broad range in order to carry out a safety function in a transient state and the event of an accident.

In order to improve the responsiveness of the water-level measurement and due to a reason seen from the diversity point of view, on the other hand, there has been studied a method for directly detecting the level of the reactor water inside the reactor and there has been proposed a water-level meter making use of a thermocouple.

In the first place, there has been known a monitoring system in which a sheathed thermocouple is included in a In-Core instrumentation tube of a boiling-water reactor. In this system, the position of the water surface is detected by making use of the fact that a temperature difference is generated between portions above and below the water surface. For more information, refer to documents such as JP-59-112290-A.

In addition, in the second place, there has been disclosed a thermocouple water-level monitoring apparatus for monitoring the water level in the upper plenum of a pressurised-water reactor vessel even though this apparatus is not provided for the purpose of diversifying the water-level meters for the boiling-water reactor. The thermocouple water-level monitoring apparatus is known to have a storage tube, a plurality of water-level detector guide tubes in the storage tube and a water-level detector passing through each of the water-level detector guide tubes. For more information, refer to documents such as JP-8-220284-A. In the thermocouple water-level monitoring apparatus, the water-level detector includes a thermocouple, which forms a cold junction and a hot junction, as well as a heat generating wire provided at a position adjacent to the hot junction. Each of the water-level detector guide tubes is supported in the storage tube by a dripping prevention plate whereas the storage tube has an air-bubble separation section provided at the lower portion thereof to serve as a section for preventing air-bubble mixing.

### SUMMARY OF THE INVENTION

The water-level meter making use of a thermocouple like the one disclosed in patent reference JP-59-11290-A or JP-8-220284-A described above can be combined with the water-level meter making use of a differential-pressure transmitter to serve as the water-level meter of the conventional boiling-water reactor for the purpose of diversification and the purpose of providing redundancy. Thus, it is possible to considerably reduce the possibility that measurements cannot be carried out.

By merely combining the water-level meter making use of the thermocouple with the conventional water-level meter, however, if one of the water-level meters fails, it is difficult to determine which water-level meter is displaying a correct indicated value so that the reliability of the indicated value cannot be improved. In order to improve the reliability of the indicated value, it is important to evaluate the soundness of the measurement system including sensors and signal transmission lines and make sure of that the indicated value is reliable.

In addition, the detection system (of the water-level meter making use of the thermocouple) itself possibly fails or is probably damaged. Thus, reduction of the possibility that the detection system fails or is damaged is effective for improving the reliability of the indicated value.

It is therefore an object of the present invention to provide a reactor water-level/temperature measurement apparatus capable of evaluating the soundness of a detection section making use of thermocouples as well as the soundness of a signal transmission section and make sure of ing the reliability of a indicated value. In addition, it is another object of the present invention to provide a reliable reactor water-level/temperature measurement apparatus capable of reducing breakages and failures occurring in the detection section making use of thermocouples.

In order to achieve the objects described above, the present invention provides a reactor water-level/temperature measurement apparatus for detecting a water level in a reactor on the basis of temperatures measured by making use of a plurality of thermocouples installed inside a reactor pressure vessel. The reactor water-level/temperature measurement apparatus comprises: an in-core instrumentation housing welded to the bottom of the pressure vessel; an in-core instrumentation guide tube placed between the upper portion of the in-core instrumentation housing and a reactor-core support plate; an in-core instrumentation tube inserted into the in-core instrumentation housing and the in-core instrumentation guide tube; a water-level/temperature detection sensor including one of the thermocouples and a heater wire, the thermocouples being installed at a plurality of vertical positions inside the in-core instrumentation tube; a temperature measurement device for measuring the temperatures of the thermocouples; a heater control device for controlling a current flowing to the heater wire; a storage device used for storing a threshold-value table associating a temperature indicated by the thermocouple before a current flows to the heater wire and a temperature increase indicated by the thermocouple while a current is flowing to the heater wire with a steam atmosphere, a water atmosphere and a sensor failure; a water-level/temperature/sensor-failure determination device for comparing a thermocouple temperature measured by the temperature measurement device before a current flows to the heater wire as well as a thermocouple temperature increase measured by the temperature measurement device while a current is flowing to the heater wire with the contents of the threshold-value table and for determining whether the environment of the water-level/temperature detection sensor is a steam atmosphere or a water atmosphere or for determining whether or not the water-level/temperature detection sensor has failed in order to generate information on reactor water levels, reactor temperatures and sensor failures on the basis of data representing determination results; and a display device for displaying the information on reactor water levels, reactor temperatures and sensor failures.

In addition, as another example, the present invention also provides a reactor water-level/temperature measurement apparatus for detecting a water level in a reactor on the basis of temperatures measured by making use of a plurality of thermocouples installed inside a reactor pressure vessel. The reactor water-level/temperature measurement apparatus comprises: an in-core instrumentation housing welded to the bottom of the pressure vessel; an in-core instrumentation guide tube placed between the upper portion of the in-core instrumentation housing and a reactor-core support plate; an in-core instrumentation tube inserted into the in-core instrumentation housing and the in-core instrumentation guide tube and placed at a location adjacent to an outermost-circumference fuel of the reactor or a location outside the outermost-circumference fuel; a water-level/temperature detection sensor including one of the thermocouples installed at a plurality of vertical positions inside the in-core instrumentation tube; a temperature measurement device for measuring the temperatures of the thermocouples; a water-level/temperature/sensor-failure determination device for determining whether the environment of the water-level/temperature detection sensor is a steam atmosphere or a water atmosphere or for determining whether or not the water-level/temperature detection sensor has failed on the basis of the temperature of the thermocouple in order to generate information on reactor water levels, reactor temperatures and sensor failures on the basis of data representing determination results; and a display device for displaying the information on reactor water levels, reactor temperatures and sensor failures.

In accordance with the present invention, it is possible to provide a reactor water-level/temperature measurement apparatus capable of evaluating the soundness of a detection section making use of thermocouples as well as the soundness of a signal transmission section and make sure of ing the reliability of a indicated value. In addition, it is also possible to provide a reliable reactor water-level/temperature measurement apparatus capable of reducing breakages and failures occurring in the detection section making use of thermocouples. Thus, the reliability of the reactor water-level/temperature measurement apparatus can be improved.

### BRIEF DESCRIPTION OF THE DRAWINGS

FIG. 1 is a conceptual diagram showing a system configuration of a first embodiment;

FIG. 2 is a diagram showing a cross section of the core of a reactor;

FIG. 3 is a diagram showing the structure of each water-level/temperature detection sensor;

FIG. 4 is a diagram showing another structure of the water-level/temperature detection sensor;

FIG. 5 is a flowchart representing processing to measure a water level and temperatures in a reactor;

FIG. 6 is an explanatory diagram showing a current pattern;

FIG. 7 is an explanatory diagram showing a typical threshold-value table;

FIG. 8 is an explanatory diagram showing another typical threshold-value table;

FIG. 9 is explanatory diagrams showing a flow suppression structure of the water-level/temperature detection sensor;

FIG. 10 is an explanatory diagram showing a flow suppression structure of the water-level/temperature detection sensor;

FIG. 11 is an explanatory diagram showing a flow suppression structure of the water-level/temperature detection sensor;

FIG. 12 is an explanatory diagram showing typical installation of the flow suppression structure;

FIG. 13 is an explanatory diagram showing typical installation of the flow suppression structure;

FIG. 14 is an explanatory diagram showing a display of water levels and their time-series data;

FIG. 15 is a flowchart representing processing to measure a water level and temperatures in a second embodiment;

FIG. 16 is an explanatory diagram to be referred to in description of typical control of a current following to a heater in the second embodiment;

FIG. 17 is a flowchart representing processing to measure a water level and temperatures in a third embodiment;

FIG. 18 is a conceptual diagram showing a system configuration of a fourth embodiment;

FIG. 19 is a diagram showing the configuration of a resistance measurement device according to the fourth embodiment;

FIG. 20 is a diagram showing a cross section of a reactor core according to a fifth embodiment;

FIG. 21 is a diagram showing a cross section of a reactor core according to a sixth embodiment; and

FIG. 22 is an explanatory diagram showing a typical display of a 3-dimensional temperature distribution inside a reactor pressure vessel according to the sixth embodiment.

### DESCRIPTION OF THE PREFERRED EMBODIMENTS

Embodiments of the present invention are explained by referring to the diagrams as follows.

### First Embodiment

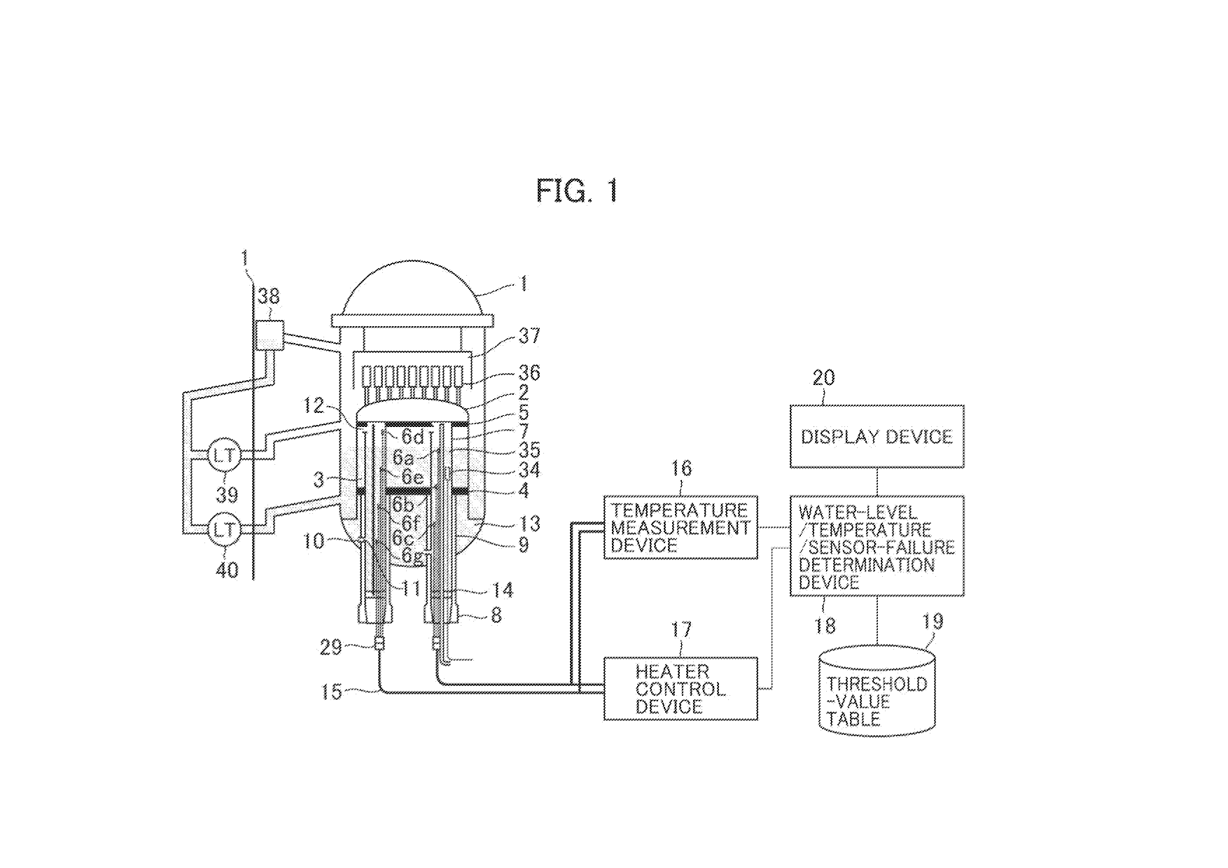

FIG. 1 is a conceptual diagram showing a system configuration of a first embodiment.

A reactor core 3 surrounded by a shroud 2 is set inside a reactor pressure vessel 1. A number of fuel assemblies inside the reactor core 3 are supported by a reactor-core support plate 4 and a grid plate 5. The fuel assemblies themselves are not shown in the figure. A plurality of water-level/temperature detection sensors 6 are provided at different vertical positions in a plurality of in-core instrumentation tubes 7 inserted into the reactor core 3. FIG. 1 shows only 2 in-core instrumentation tubes 7 each including 4 water-level/temperature detection sensors 6. The lower portion of the in-core instrumentation tube 7 is inserted into an in-core instrumentation housing 8 and an in-core instrumentation guide tube 9 which are provided in the lower portion of the reactor pressure vessel 1. On the other hand, the upper portion of the in-core instrumentation tube 7 is fixed on the grid plate 5. On the in-core instrumentation housing 8 and the in-core instrumentation tube 7, water passing holes 10, 11 and 12 are provided. The water passing holes 10 and 11 are provided below the water-level/temperature detection sensor 6 whereas the water passing hole 12 is provided at a location in close proximity to the upper edge of the in-core instrumentation tube 7. When the reactor water level falls down to a level lower than the grid plate 5, cooling water 13 flows so that the water level inside the in-core instrumentation tube 7 matches the reactor water level. Inside the in-core instrumentation tube 7, a water stopping plug 14 is provided at a position lower than the water passing hole 11 so that no cooling water 13 leaks from the lower edge of the in-core instrumentation tube 7. The water-level/temperature detection sensor 6 is connected to signal and heater cables 15 which are extended from the lower edge of the in-core instrumentation tube 7 to the outside of the reactor pressure vessel 1 and connected to a temperature measurement device 16 and a heater control device 17.

A water-level meter based on the conventional differential pressure transmitter measures a pressure difference by making use of differential-pressure transmitters 39 and 40. The pressure difference is a difference between a pressure of a reference water pole having a constant height and a reactor water pressure drawn by an instrumentation tube from the outside of the shroud 2 of the reactor pressure vessel 1. The reference water pole having a constant height is created in the instrumentation tube connected to a lower portion by a steam condensate pot 38. It is to be noted that, in the reference water, there is a provided a mechanism in which steam reaching the upper portion of the reactor pressure vessel 1 by way of a steam separator 36 and a steam dryer 37 is cooled by the steam condensate pot 38 in order to always hold a constant water-surface height. In the reactor water-level/temperature measurement apparatus according to this embodiment, the measurement range overlaps that of the conventional water-level meter in an area of the reactor core 3 so that, by combining the measurement range of the reactor water-level/temperature measurement apparatus with that of the conventional water-level meter, it is possible to measure the water level in a continuous measurement range from the upper portion of the reactor pressure vessel 1 to the bottom of the reactor pressure vessel 1.

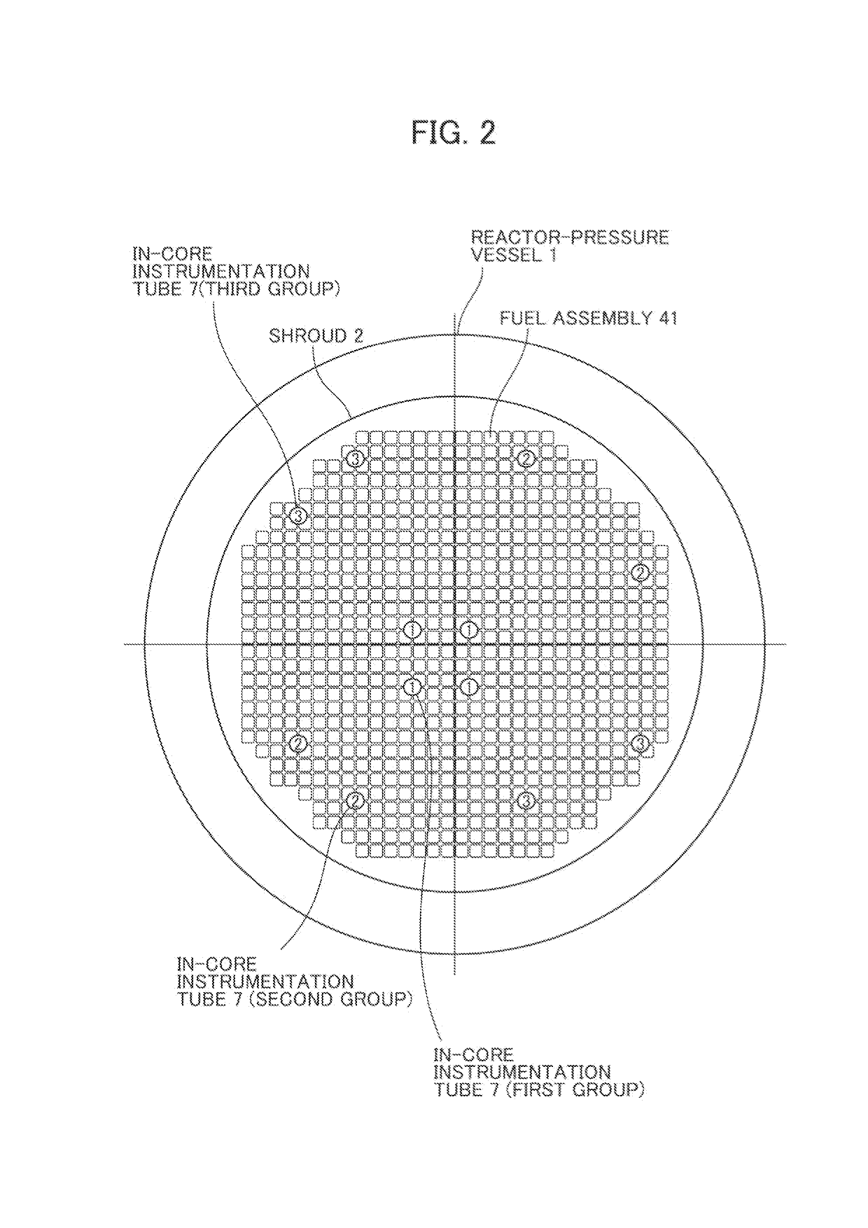

FIG. 2 is a diagram showing a cross section seen in a portion of the reactor core 3 as a cross section of the reactor pressure vessel 1.

In FIG. 1, only 2 in-core instrumentation tubes 7 are shown as described earlier. As shown in FIG. 2, however, 8 or more in-core instrumentation tubes 7 can also be inserted into gaps between fuel assemblies 41. A number of in-core instrumentation tubes 7 are used by providing them in such a way that the heights of water-level/temperature detection sensors 6 for the in-core instrumentation tubes 7 are made different from each other for the purpose of interpolation to find a water level. In this way, a water level can be detected at finer gaps. For example, as shown in FIG. 2, the in-core instrumentation tubes 7 are divided into first, second and third groups. For the in-core instrumentation tubes 7 pertaining to the some groups, the heights of the water-level/temperature detection sensors 6 are made different from each other in order to determine one water level for each of the some groups. For example, in the case of the first group, one water level is determined for 4 in-core instrumentation tubes 7. In this way, a finer water level can be detected. It is to be noted that, as shown in FIG. 1, a water-level/temperature detection sensor 6 can be accommodated in an existing in-core instrumentation tube 7 which accommodates a neutron detector 34 and a scan-type neutron detector guide tube 35.

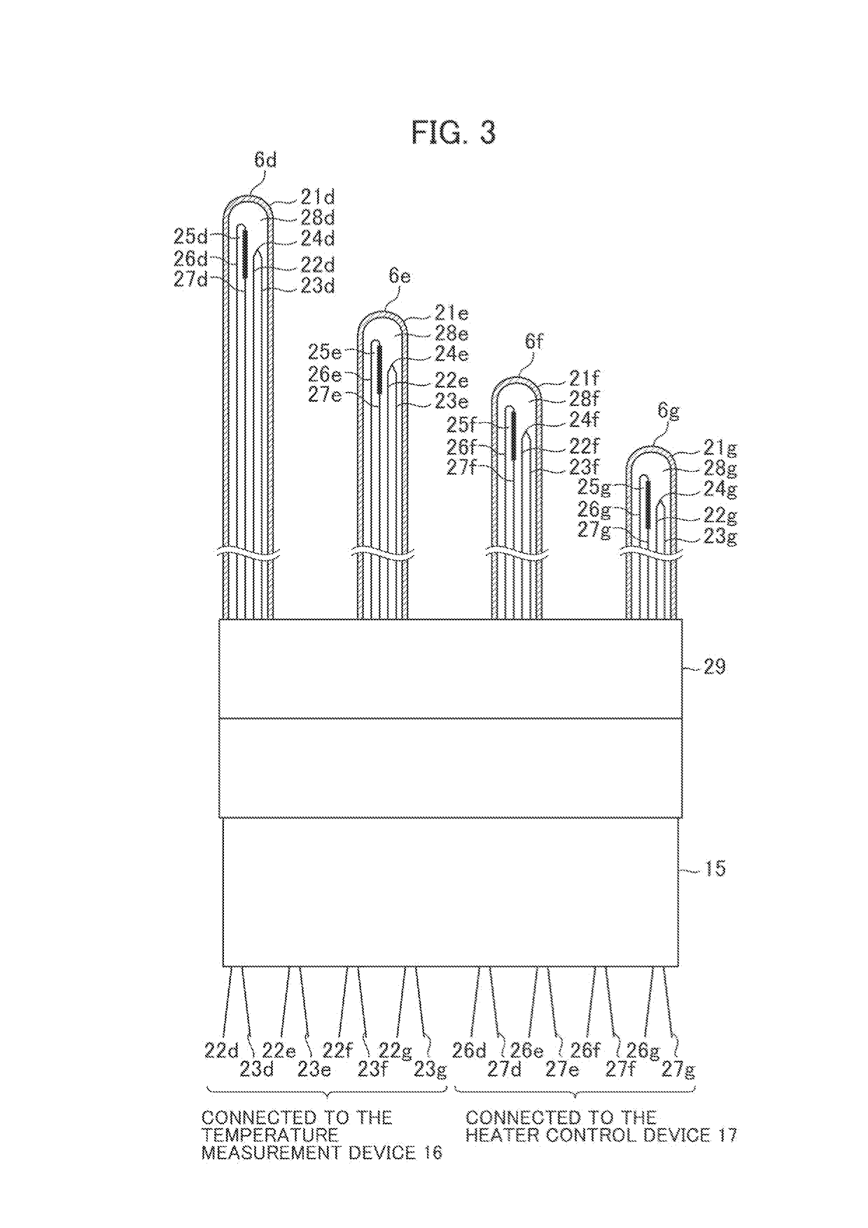

FIG. 3 is a diagram showing the structure of each water-level/temperature detection sensor 6. FIG. 3 shows 4 water-level/temperature detection sensors 6, that is, water-level/temperature detection sensors 6d to 6g. Since the water-level/temperature detection sensors 6d to 6g have the same structure, the following description explains only the structure of the water-level/temperature detection sensor 6d.

Inside the water-level/temperature detection sensor 6d, there are accommodated a thermocouple 24d, a heater wire 25d as well as heater lead wires 26d and 27d. The thermocouple 24d is created by bonding a thermocouple +side wire 22d and a thermocouple −side wire 23d to each other. The heater wire 25d is a wire for heating the neighborhood of the thermocouple 24d. As the thermocouple 24d, it is possible to make use of a K-type or N-type thermocouple which has already been used widely. In addition, as the heater wire 25d, a high-resistance wire or the like is appropriate. An example of the heater wire 25d is a high-resistance wire made of a nickel-chromium alloy. The heater lead wires 26d and 27d are each a wire having a relatively low resistance. An example of the wire having a relatively low resistance is a wire made of copper, nickel or the like. By making use of wires each having a relatively low resistance as the heater lead wires 26d and 27d, it is possible to control a voltage required for the power supply of the heater wire 25d. The thermocouple 24d and the heater wire 25d are electrically insulated from each other by an insulator 28 made of aluminum or the like. The thermocouple 24d, the heater wire 25d as well as the heater lead wires 26d and 27d are accommodated in typically a sheath 21d made of stainless steel or the like. The thermocouple +side wire 22d, the thermocouple −side wire 23d as well as the heater lead wires 26d and 27d are connected to signal and heater cables 15 through a connector 29 in order to connect the thermocouple +side wire 22d and the thermocouple −side wire 23d to a temperature measurement device 16 and in order to connect the heater lead wires 26d and 27d to a heater control device 17.

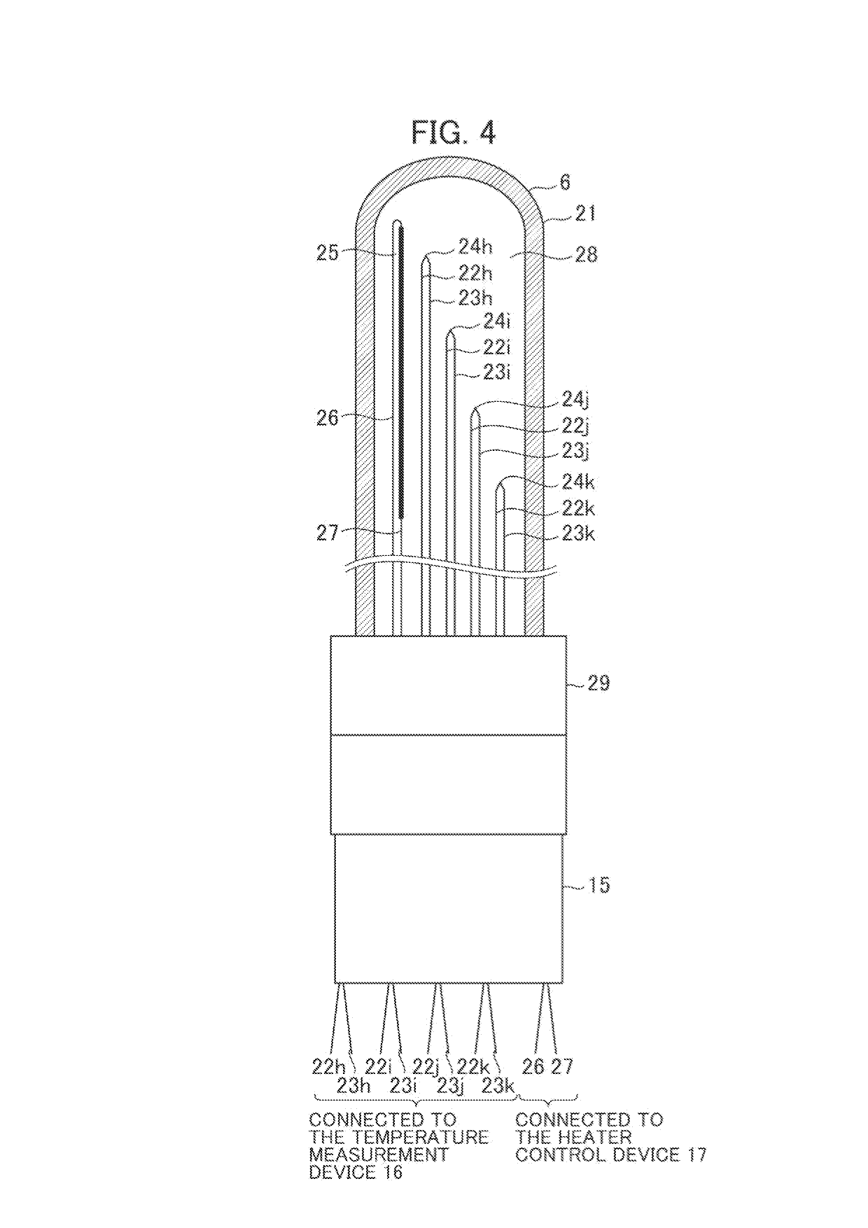

FIG. 4 is a diagram showing another structure of the water-level/temperature detection sensor 6.

In this typical structure, the heater wire 25 is shared by 4 thermocouples 24h to 24k which are accommodated in the same sheath 21 made of stainless steel or the like. The thermocouple +side wires 22h to 22k and the thermocouple −side wires 23h to 23k are connected to the temperature measurement device 16. On the other hand, the heater lead wires 26 and 27 are connected to the heater control device 17.

As shown in FIG. 1, the temperature measurement device 16 and the heater control device 17 are connected to a water-level/temperature/failure determination device 18. The water-level/temperature/failure determination device 18 is also connected to a storage device 19 and a display device 20. The storage device 19 is a memory used for storing a threshold-value table.

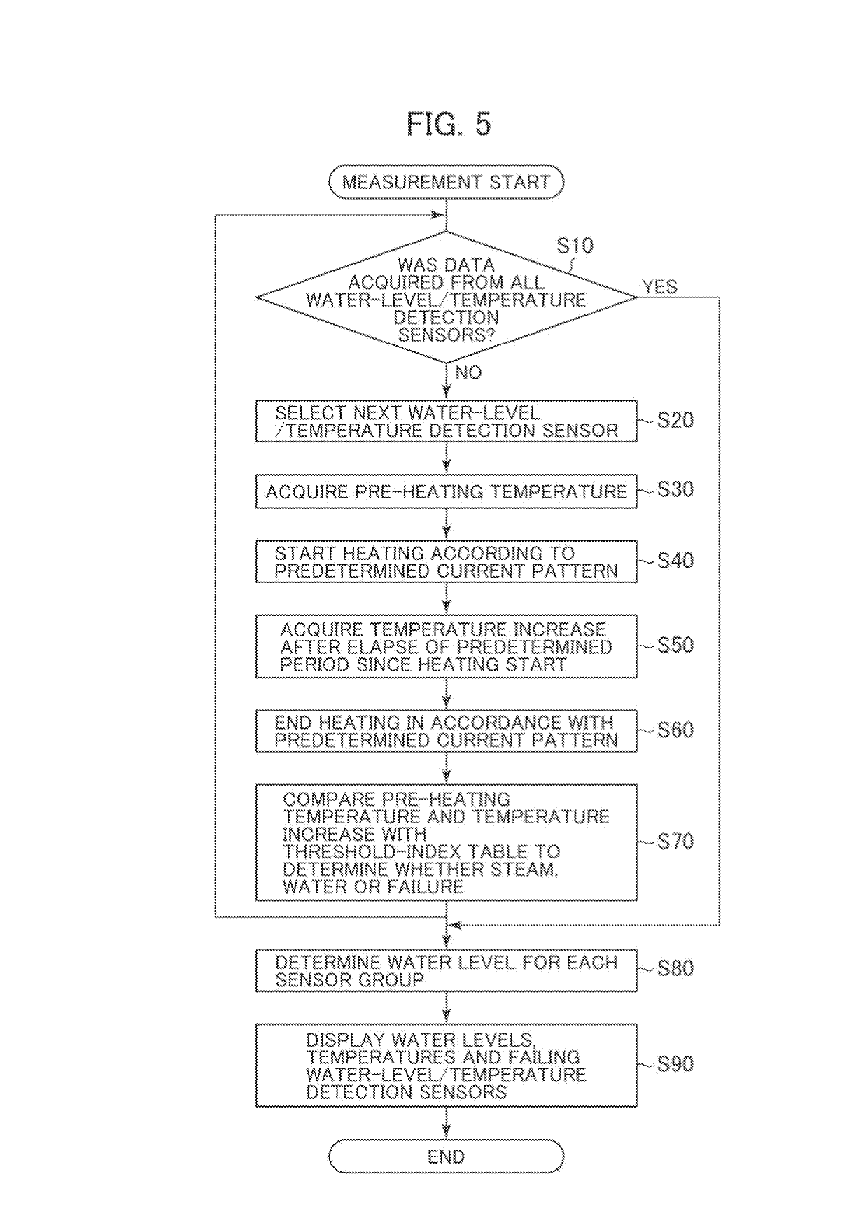

Next, by referring to FIG. 5, operations carried out by the reactor water-level/temperature measurement apparatus shown in FIGS. 1 to 4 are explained. FIG. 5 is a flowchart representing processing to measure a water level and temperatures in a reactor. The measurement of a water level and temperatures is started by the water-level/temperature/failure determination device 18 periodically.

At a step S10, the water-level/temperature/failure determination device 18 determines whether or not to repeat control described below in accordance with a sequence determined in advance for the next water-level/temperature detection sensor 6 in order to obtain data from all the water-level/temperature detection sensors 6 as data necessary for determining water levels, temperatures and failures.

First of all, at steps S20 and S30, the temperature measurement device 16 is given a command to obtain pre-conduction temperature data, which is a temperature before electrical conduction of the heater wire 25, from the water-level/temperature detection sensor 6 currently being processed. In the following description, the water-level/temperature detection sensor 6 currently being processed is referred to simply as the current water-level/temperature detection sensor 6. Receiving the command to obtain the temperature data, the temperature measurement device 16 inputs a signal generated by the current water-level/temperature detection sensor 6 as a signal representing the temperature data and supplies the signal to the water-level/temperature/failure determination device 18. The water-level/temperature/failure determination device 18 stores the temperature data received from the current water-level/temperature detection sensor 6 in a storage device shown in none of the figures.

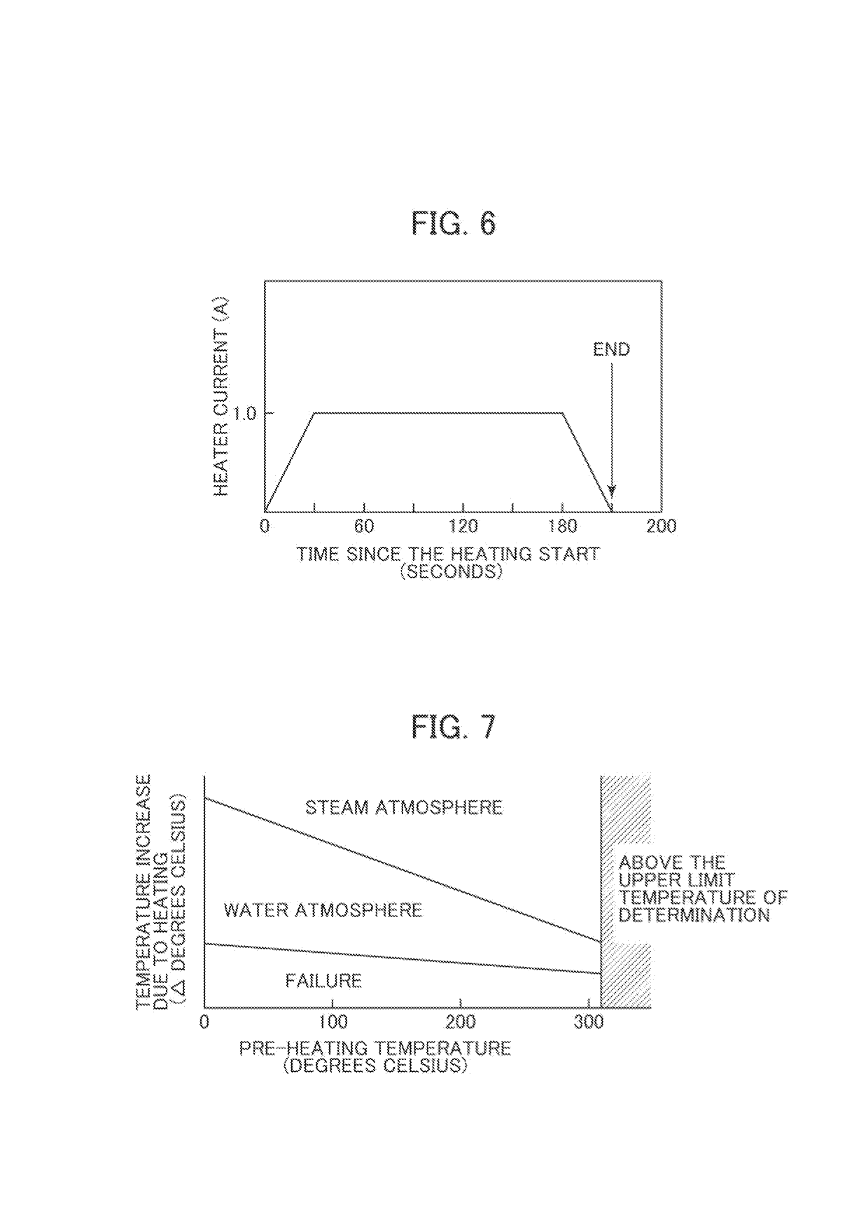

Then, at the next step S40, a command is given to the heater control device 17 in order to put the heater wire 25 of the current water-level/temperature detection sensor 6 in an electrically conductive state. Receiving the command, the heater control device 17 puts the heater wire 25 in an electrically conductive state by allowing a current to flow through the heater wire 25 in accordance with an embedded current pattern. As the pattern, it is possible to make use of a pattern like one shown in FIG. 6. As a current flows through the heater wire 25, Joule heat dissipated by the heat wire 25 increases the ambient temperature of the heater wire 25 employed in the current water-level/temperature detection sensor 6. Then, at the next step S50, after the elapse of an electrical conduction period determined in advance for the heater wire 25 since the start of the electrically conductive state, the water-level/temperature/failure determination device 18 gives the temperature measurement device 16 a command to obtain temperature data for the electrically conductive state. Receiving the command to obtain the temperature data, the temperature measurement device 16 inputs a signal generated by the current water-level/temperature detection sensor 6 as a signal representing the temperature data and supplies the signal to the water-level/temperature/failure determination device 18. The water-level/temperature/failure determination device 18 stores the temperature data received from the current water-level/temperature detection sensor 6 in a storage device shown in none of the figures and, at the same time, gives the heater control device 17 a command to terminate the electrically conductive state in accordance with the embedded current pattern at a step S60. Then, at the next step S70, the water-level/temperature/failure determination device 18 compares the temperature data and temperature increase data received from the current water-level/temperature detection sensor 6 with the contents of the threshold-value table stored in advance in the storage device 19 in order to determine whether the environment of the water-level/temperature detection sensor 6 is a steam atmosphere or a water atmosphere or in order to determine whether or not the current water-level/temperature detection sensor 6 has failed. The control described above is repeated for all water-level/temperature detection sensors 6 in order to obtain data from all the water-level/temperature detection sensors 6 as data necessary for determining a water level, temperatures and failures.

FIG. 7 is an explanatory diagram showing a typical threshold-value table.

The threshold-value table used for storing threshold values used for determining whether the environment of a water-level/temperature detection sensor 6 is a steam atmosphere or a water atmosphere and for determining whether the environment of the water-level/temperature detection sensor 6 is a water atmosphere or the water-level/temperature detection sensor 6 has failed on the basis of a temperature increase (Δ degrees Celsius) obtained as a result of a current flowing through the heater wire 25 in an electrically conductive state of the heater wire 25. The threshold values are stored in the threshold-value table for every temperature (degrees Celsius) detected before a current flows through the heater wire 25. The absolute value of a threshold value changes in accordance with factors including the structure of the water-level/temperature detection sensor 6 and the magnitude of a current flowing to the heater. Thus, the thermal conductivity of steam rises with the temperature increase of the steam. Accordingly, the threshold value used for determining whether the environment of the water-level/temperature detection sensor 6 is a steam atmosphere or a water atmosphere decreases with the temperature increase. In addition, the thermal conductivity of water also rises with the temperature increase of the water. However, the rate of the increase of the thermal conductivity for water is small in comparison with the rate of the increase of the thermal conductivity for steam. Thus, the threshold value decreases a little bit with the temperature increase. When the temperature of the cooling water 13 approaches the critical temperature of 374 degrees Celsius, the threshold value between the steam atmosphere and the water atmosphere approaches the threshold value between the water atmosphere and a failure of the water-level/temperature detection sensor 6 so that it is difficult to determine whether the environment of a water-level/temperature detection sensor 6 is a steam atmosphere or a water atmosphere and to determine whether the environment of the water-level/temperature detection sensor 6 is a water atmosphere or the water-level/temperature detection sensor 6 has failed. In the case of this example, a temperature equal to or higher than 310 degrees Celsius is not subjected to determination.

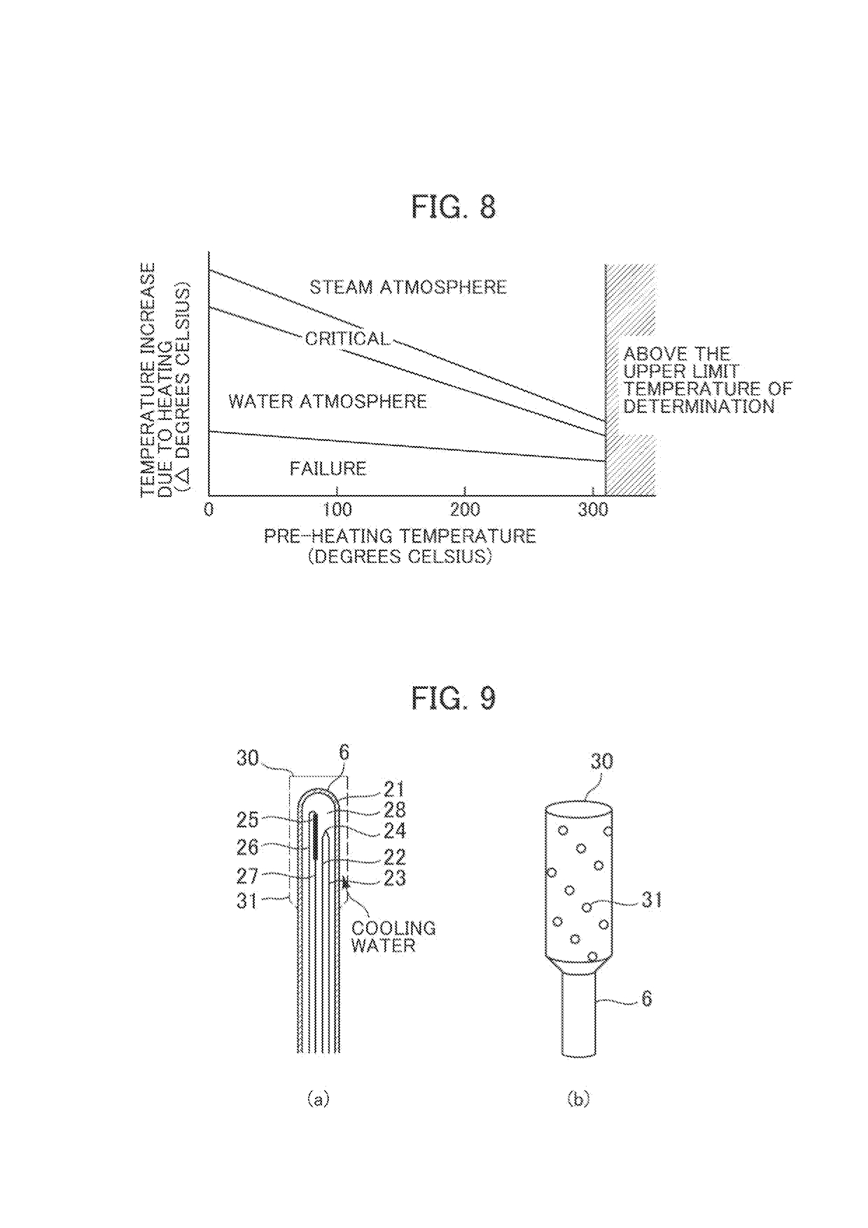

FIG. 8 is an explanatory diagram showing another typical threshold-value table. This threshold-value table is about the same as that shown in FIG. 7. In the case of the threshold-value table shown in FIG. 8, however, a critical area is set between the steam and water atmospheres. In the case of a temperature increase detected as a temperature increase in the critical area, the water-level/temperature/failure determination device 18 determines that a water level exists in the neighborhood of the water-level/temperature detection sensor 6.

FIG. 9 is diagrams showing a water-level/temperature detection sensor 6 having a structure for reducing the effect of an existing flow of a coolant. The water-level/temperature detection sensor 6 shown in this figure is used for applying the determination based on a threshold value as determination as to whether the environment of a water-level/temperature detection sensor 6 is a steam atmosphere or a water atmosphere and to determine whether the environment of a water-level/temperature detection sensor 6 is a water atmosphere or the water-level/temperature sensor has failed to a case in which such a flow exists.

The water-level/temperature detection sensor 6 has a structure wherein the vicinity of an edge on which the heater wire 25 of the water-level/temperature detection sensor 6 is set is covered by a flow suppression structure 30 and a water passing hole 31 provided on the surface of the flow suppression structure 30 allows the cooling water 13 to flow from the outside to the inside of the flow suppression structure 30 but the flow itself is suppressed. The flow suppression structure 30 allows the threshold-value tables shown in FIGS. 7 and 8 to be used even for a case in which the flow of a coolant exists.

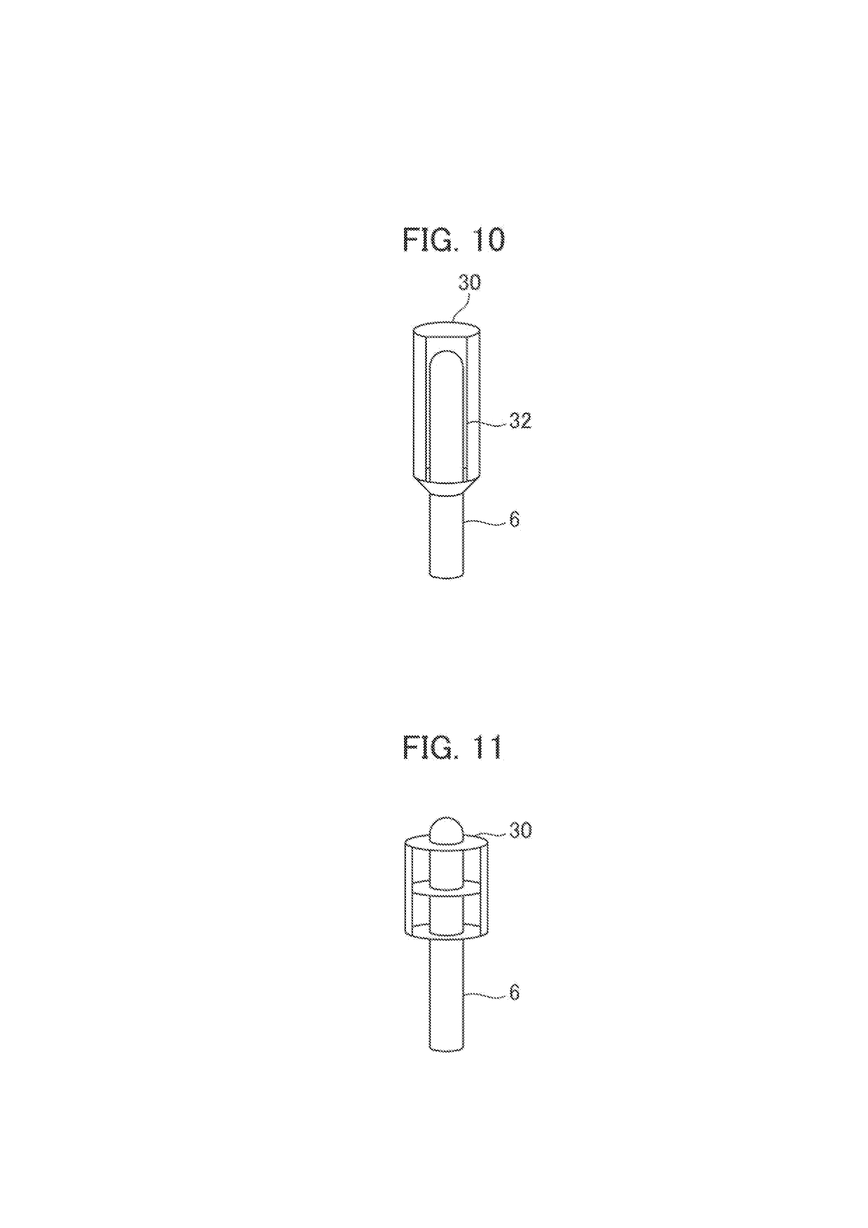

FIGS. 10 and 11 are each an explanatory diagram showing another typical flow suppression structure 30 of the water-level/temperature detection sensor 6.

As shown in FIG. 10, in order to put cooling water 13 inside the flow suppression structure 30, an opening 32 is provided. As shown in FIG. 11, on the other hand, the flow suppression structure 30 is configured by incorporating a circular plate for suppressing the flow.

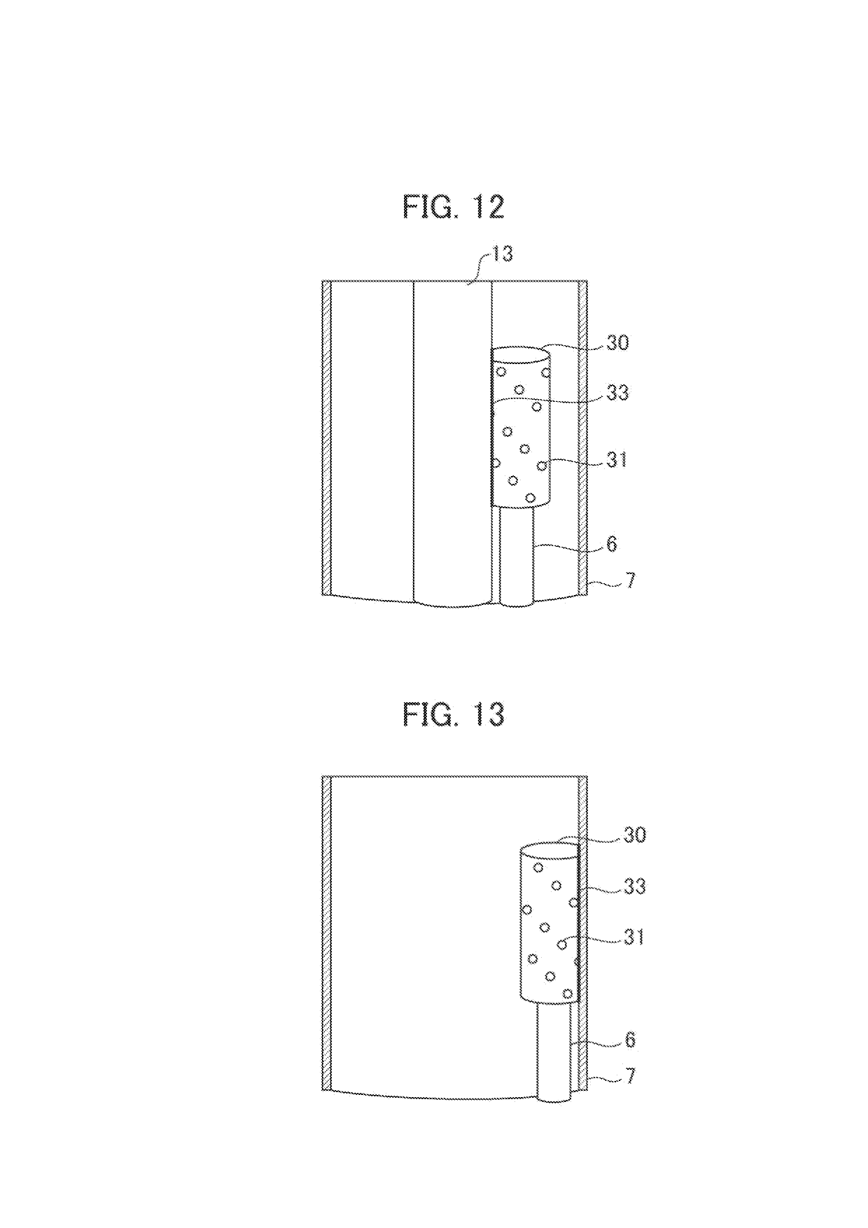

As shown in FIGS. 9 to 11, such a flow suppression structure 30 is fixed on the water-level/temperature detection sensor 6. In addition, as shown in FIG. 12, the flow suppression structure 30 can also be fixed on the scan-type neutron detector guide tube 35, which is provided inside the existing in-core instrumentation tube 7, through a weld portion 33. As an alternative, as shown in FIG. 13, the flow suppression structure 30 can also be fixed inside the in-core instrumentation tube 7 through a weld portion 33.

At a step S80 of the flowchart shown in FIG. 5, results of the determinations carried out on the water-level/temperature detection sensors 6 as described above are arranged by the water-level/temperature/failure determination device 18 for each of the sensor groups shown in FIG. 2 in the installation-height order. Then, an intermediate height is determined to be the height of the water level. The intermediate height determined to be the height of the water level is a height between the height of a water-level/temperature detection sensor 6 installed at the lowest vertical position among the water-level/temperature detection sensors 6 in the steam atmosphere and the height of a water-level/temperature detection sensor 6 installed at the highest vertical position among the water-level/temperature detection sensors 6 in the water atmosphere.

As an alternative, if a water-level/temperature detection sensor 6 determined to be a sensor in the critical area exists, the installation height of the water-level/temperature detection sensor 6 is determined to be the height of the water level. If there is a contradiction in the determination results for water-level/temperature detection sensors 6 pertaining to a group, the water level is determined to be unclear. A contradiction in the determination results can be typically a case in which a water-level/temperature detection sensor 6 at an installation position higher than a water-level/temperature detection sensor 6 determined to be a sensor in the steam atmosphere is determined to be a sensor in the water atmosphere. A contradiction in the determination results can also be typically a case in which the temperature detected before the electrically conductive state of the heater wire 25 is a temperature in the range not subjected to determination as described above. Then, at the next step S90, the determined water level is stored in a memory, which is shown in none of the figures, as time-series data and displayed in the display device 20.

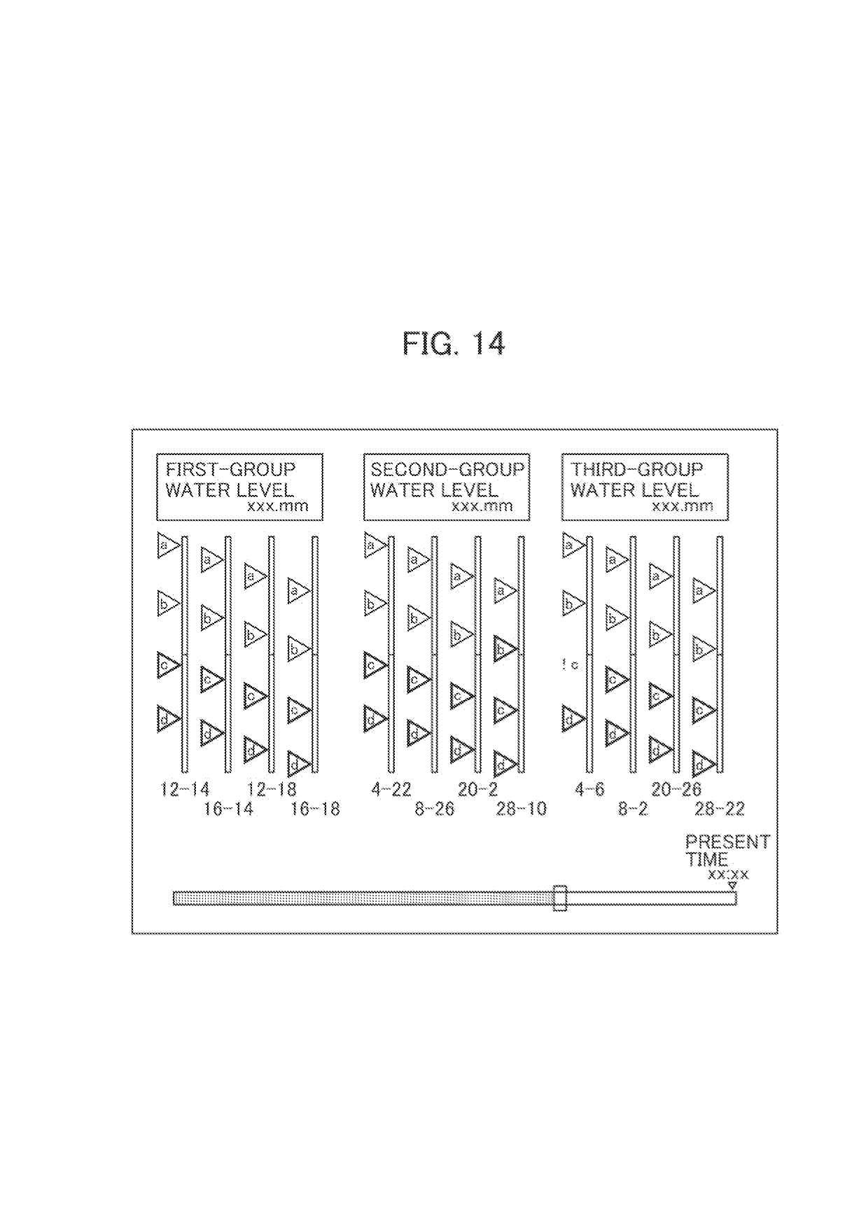

FIG. 14 is a diagram showing a screen displaying typical measurement results of the water level.

FIG. 14 shows measurement results of the water level for a typical configuration in which the water-level/temperature detection sensors 6 are divided into 3 sensor groups and 4 in-core instrumentation tubes 7 are allocated to each of the sensor groups. In addition, 4 water-level/temperature detection sensors 6 are provided inside each of the in-core instrumentation tubes 7. Each of the in-core instrumentation tubes 7 is shown as a vertical rod. Numbers such as 12-14 below the vertical rod represent a radial-direction installation position in the reactor. A horizontal-line position shown above the 4 vertical rods for a sensor group as the position of a horizontal line is the water level. The water atmosphere is an atmosphere below the horizontal line representing the water level whereas the steam atmosphere is an atmosphere above the horizontal line. Each of the water-level/temperature detection sensors 6 provided inside an in-core instrumentation tube 7 is shown as a triangle. A water-level/temperature detection sensor 6 shown as a bold-line triangle is a water-level/temperature detection sensor 6 determined to be a sensor in the water atmosphere. The water level expressed in terms of mm units for a sensor group is shown as a text above the 4 vertical rods for the sensor group. In addition, a sensor c serving as the third sensor from the top of a in-core instrumentation tube 7 represented by numbers 4-6 in the third sensor group is a water-level/temperature detection sensor 6 which has failed. A horizontal rod shown at the bottom of the screen is a slide bar. When the operator moves a cursor along the slide bar to a position on the bar, the information displayed on the screen is changed to water-level measurement values corresponding to the position which represents a past time.

As described above, in accordance with this embodiment, even if different temperatures are detected inside the reactor pressure vessel 1, the water level can be detected with a high degree of precision and, in addition, the soundness of each water-level/temperature detection sensor 6 can be evaluated.

### Second Embodiment

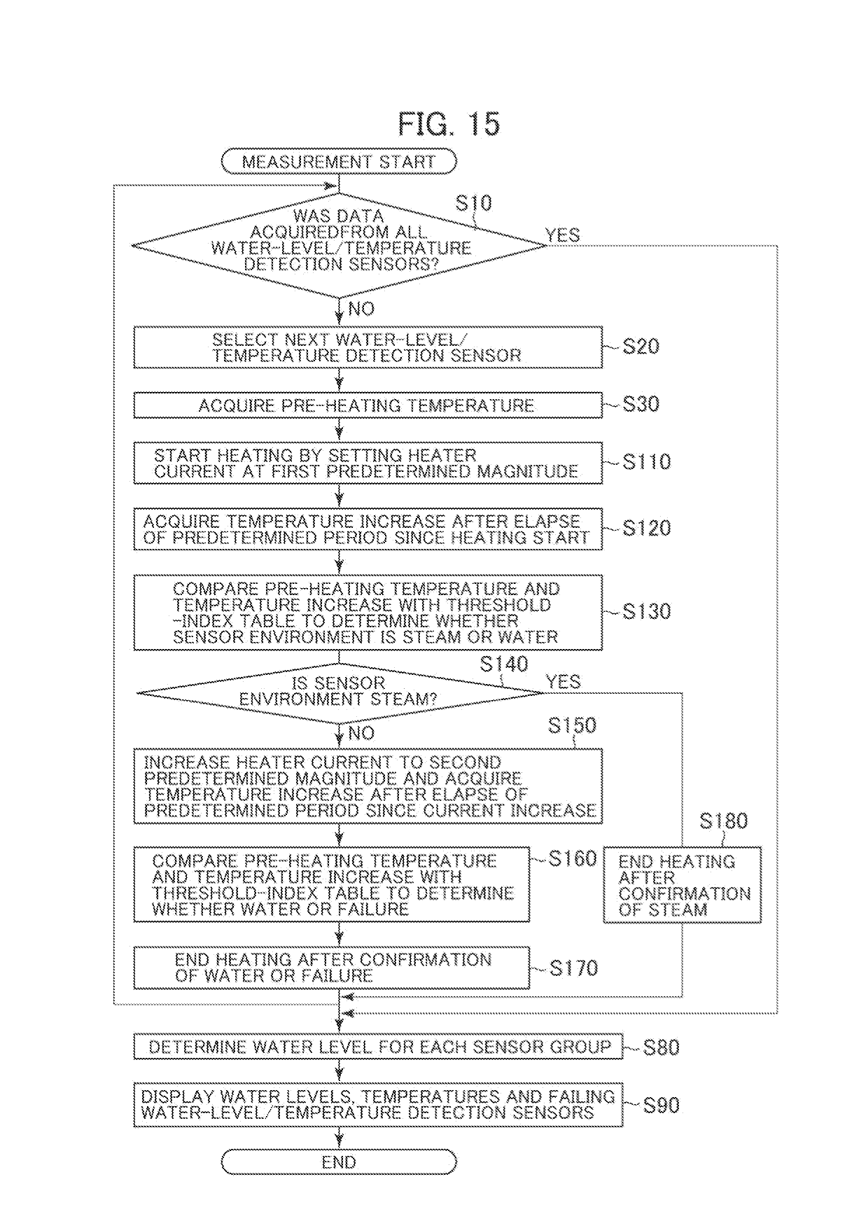

In the case of this embodiment, the apparatus configuration is identical with that shown in FIG. 1. As shown in FIG. 15, however, the flow of the processing carried out to measure a water level and temperatures in the reactor is partially different from that explained earlier by referring to FIG. 5. It is to be noted that, in FIG. 15, a step denoted by the same reference numeral as that used in FIG. 5 represents the same operation as that of FIG. 5.

At a step S10, the water-level/temperature/failure determination device 18 determines whether or not to repeat control described below in accordance with a sequence determined in advance for the next water-level/temperature detection sensor 6 in order to obtain data from all the water-level/temperature detection sensors 6 as data necessary for determining water levels, temperatures and failures.

First of all, at a step S20, the temperature measurement device 16 is given a command to obtain pre-conduction temperature data, which is a temperature before electrical conduction of the heater, from the water-level/temperature detection sensor 6 currently being processed. In the following description, the water-level/temperature detection sensor 6 currently being processed is referred to simply as the current water-level/temperature detection sensor 6. Receiving the command to obtain the temperature data, the temperature measurement device 16 inputs a signal generated by the current water-level/temperature detection sensor 6 as a signal representing the temperature data and supplies the signal to the water-level/temperature/failure determination device 18 at the next step S30. Then, the water-level/temperature/failure determination device 18 stores the temperature data received from the current water-level/temperature detection sensor 6 in a storage device shown in none of the figures.

Then, at the next step S110, a command is given to the heater control device 17 in order to put the heater wire 25 of the current water-level/temperature detection sensor 6 in an electrically conductive state. Receiving the command, the heater control device 17 puts the heater wire 25 in an electrically conductive state and increases the magnitude of a current flowing through the heater wire 25 to a first current value set and embedded in advance in the heater control device 17. Then, at the next step S120, after the elapse of an electrical conduction period determined in advance for the heater wire 25 since start of the electrically conductive state, the water-level/temperature/failure determination device 18 gives the temperature measurement device 16 a command to obtain temperature data for the electrically conductive state. Receiving the command to obtain the temperature data, the temperature measurement device 16 inputs a signal generated by the current water-level/temperature detection sensor 6 as a signal representing the temperature data and supplies the signal to the water-level/temperature/failure determination device 18. The water-level/temperature/failure determination device 18 stores the temperature data received from the current water-level/temperature detection sensor 6 in a storage device shown in none of the figures. Then, at the next step S130, the water-level/temperature/failure determination device 18 compares the temperature data and temperature increase data received from the current water-level/temperature detection sensor 6 with the contents of the threshold-value table stored in advance in the storage device 19 to be used later in determination as to whether or not the environment of the water-level/temperature detection sensor 6 is a steam atmosphere.

Then, at the next step S140, the water-level/temperature/failure determination device 18 actually determines whether or not the environment of the water-level/temperature detection sensor 6 is a steam atmosphere. If the determination result produced at the step S140 indicates that the environment of the water-level/temperature detection sensor 6 is a steam atmosphere, the flow of the processing goes on to a step S180 at which the electrically conductive state of the heater wire 25 is terminated. Then, the flow of the processing goes back to the step S10 to process another water-level/temperature detection sensor 6.

If the determination result produced at the step S140 indicates that the environment of the water-level/temperature detection sensor 6 is not a steam atmosphere, on the other hand, the flow of the processing goes on to a step S150 at which the heater control device 17 is given a command to increase the magnitude of the current flowing through the heater wire 25 in order to determine whether the environment of the water-level/temperature detection sensor 6 is a water atmosphere or the water-level/temperature detection sensor 6 has failed. Receiving the command, the heater control device 17 increases the magnitude of the current to a second current value greater than the first current value. Then, after an electrical conduction period determined in advance for the heater wire 25 to which the current having the second current value is flowing has elapsed since the increase of the current to the second current value, the water-level/temperature/failure determination device 18 gives the temperature measurement device 16 a command to obtain temperature data for the electrically conductive state with the second current value. Receiving the command to obtain the temperature data, the temperature measurement device 16 inputs a signal generated by the current water-level/temperature detection sensor 6 as a signal representing the temperature data and supplies the signal to the water-level/temperature/failure determination device 18. Then, at the next step S160, the water-level/temperature/failure determination device 18 compares the temperature data and temperature increase data received from the current water-level/temperature detection sensor 6 with the contents of the threshold-value table stored in advance in the storage device 19 in order to determine whether the environment of the water-level/temperature detection sensor 6 is a water atmosphere or the water-level/temperature detection sensor 6 has failed.

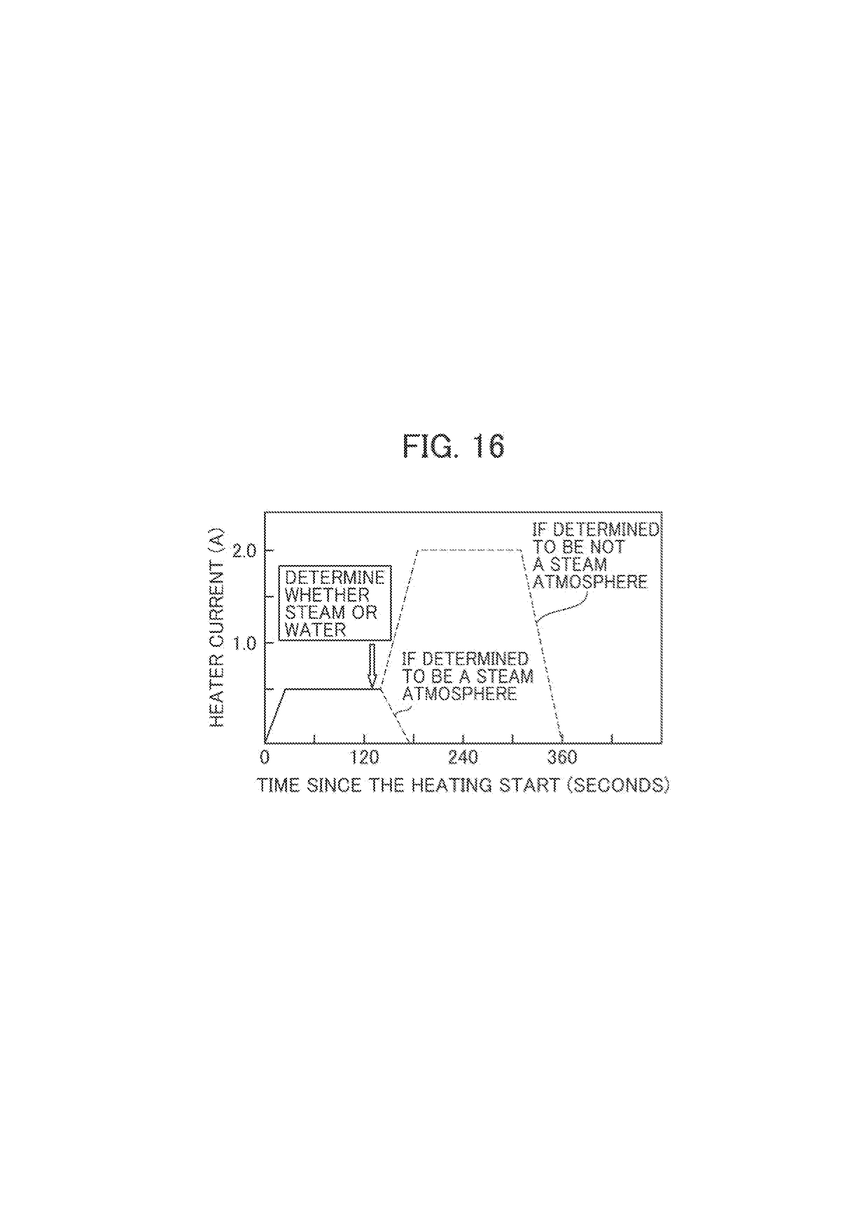

FIG. 16 is an explanatory diagram referred to in the following description of typical control of a current flowing to the heater wire 25 in the second embodiment as briefly explained above. In this control, in order to determine whether the environment of the water-level/temperature detection sensor 6 is a steam atmosphere or a water atmosphere, the magnitude of the current is set at a predetermined value of 0.5 A. Later on, only if the environment of the water-level/temperature detection sensor 6 is determined to be not a steam atmosphere, in order to determine whether the environment of the water-level/temperature detection sensor 6 is a water atmosphere or the water-level/temperature detection sensor 6 has failed, the magnitude of the current is raised to a predetermined second value of 2.0 A. This control is carried out repeatedly for all the water-level/temperature detection sensors 6 in order to obtain data necessary for determining a water level and failures. On the basis of determination results produced for the water-level/temperature detection sensors 6, a water level is determined for each sensor group and an operation to display the water level is carried out in the same way as the first embodiment.

In accordance with the second embodiment, in a steam atmosphere during which the temperature of the heater wire 25 increases with ease due to a current flowing through the heater wire 25, the magnitude of the current is deliberately controlled to a small value in order to prevent the heater wire 25 from being broken. In addition, only for a water atmosphere, that is, only if the environment of the water-level/temperature detection sensor 6 is determined to be not a steam atmosphere, the magnitude of the current flowing through the heater wire 25 is increased so as to allow the water-level/temperature/failure determination device 18 to reliably determine whether the environment of the water-level/temperature detection sensor 6 is a water atmosphere or the water-level/temperature detection sensor 6 has failed.

### Third Embodiment

A third embodiment is similar to the second embodiment. In the case of the third embodiment, however, a temperature-increase time constant is used in the operation carried out to determine whether the environment of the water-level/temperature detection sensor 6 is a steam atmosphere or a water atmosphere.

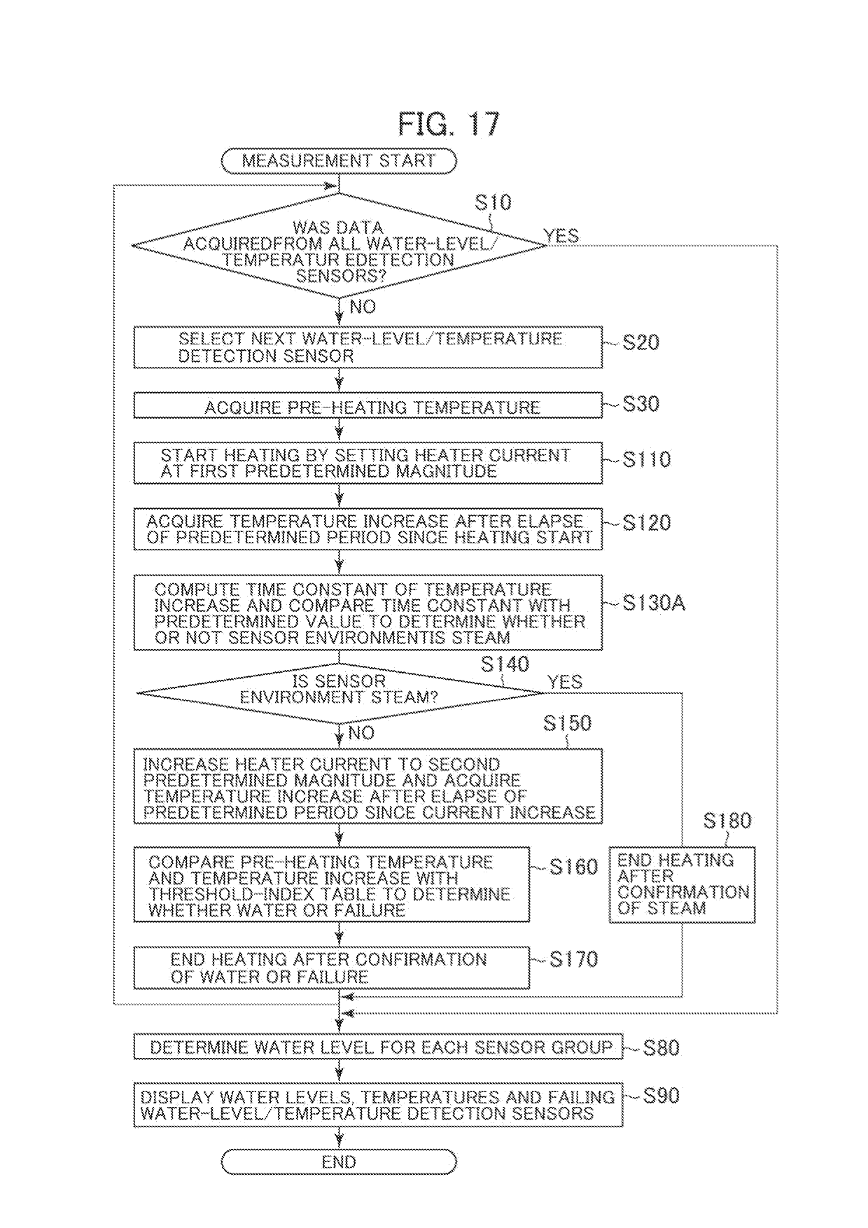

FIG. 17 is a flowchart representing processing to measure a water level and temperatures in the third embodiment. The third embodiment is different from the second embodiment in that, in the case of the third embodiment, a temperature-increase time constant is used in an operation carried out at a step S130A to determine whether the environment of the water-level/temperature detection sensor 6 is a steam atmosphere or a water atmosphere. The threshold-value table shown in FIG. 7 can be used as is the case with the second embodiment to determine whether the environment of the water-level/temperature detection sensor 6 is a water atmosphere or the water-level/temperature detection sensor 6 has failed. In accordance with the third embodiment, it is possible to shorten relatively long time required in determining whether the environment of the water-level/temperature detection sensor 6 is a steam atmosphere or a water atmosphere. It takes relatively long time to determine whether the environment of the water-level/temperature detection sensor 6 is a steam atmosphere or a water atmosphere because it is necessary to wait for the temperature to get saturated.

### Fourth Embodiment

Also in the case of the fourth embodiment, on the basis of temperature data and the threshold-value table, the water-level/temperature/failure determination device 18 detects a water level or a failure of a water-level/temperature detection sensor 6. In the case of the fourth embodiment, in addition to this method of making use of temperature data and the threshold-value table, there is also provided another method which can be adopted in conjunction with the method of making use of temperature data and the threshold-value table. In accordance with this other method, the loop resistance of the water-level/temperature detection sensor 6 and an insulator resistance are measured.

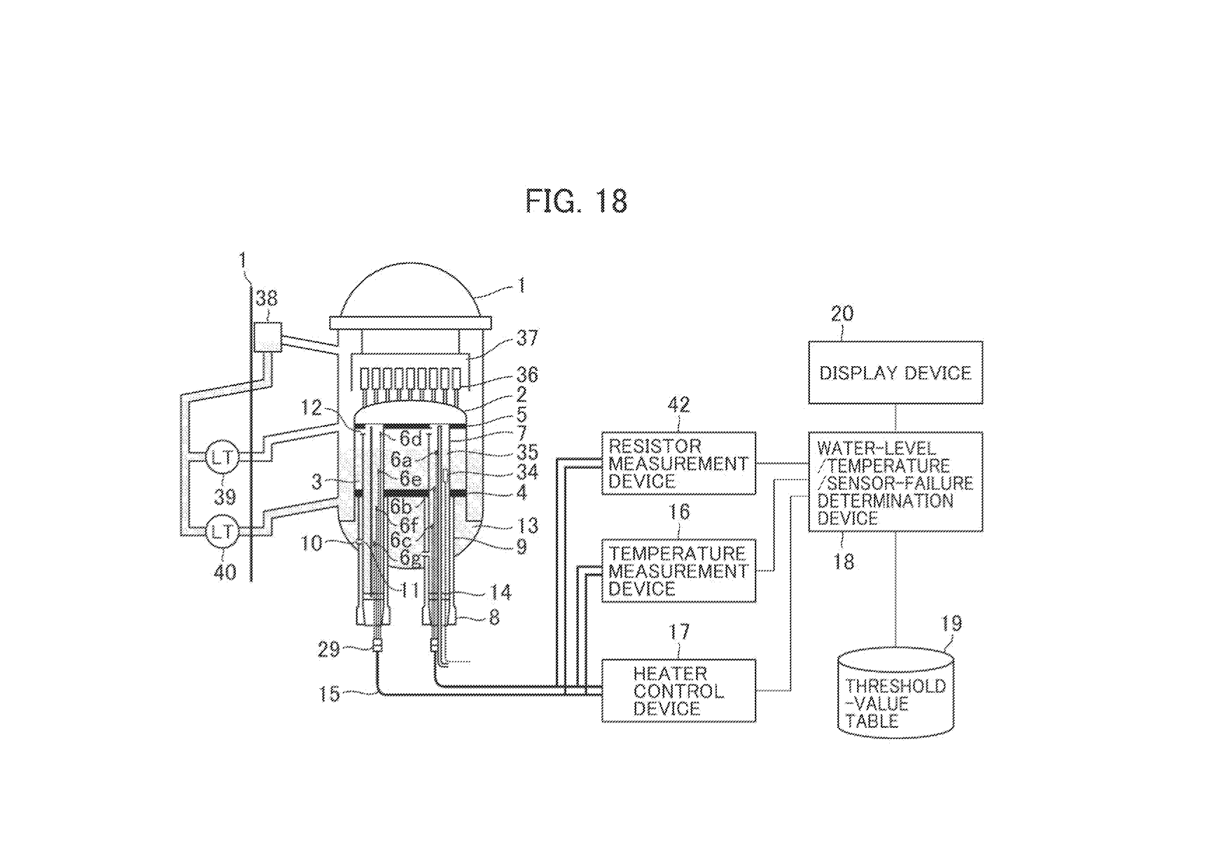

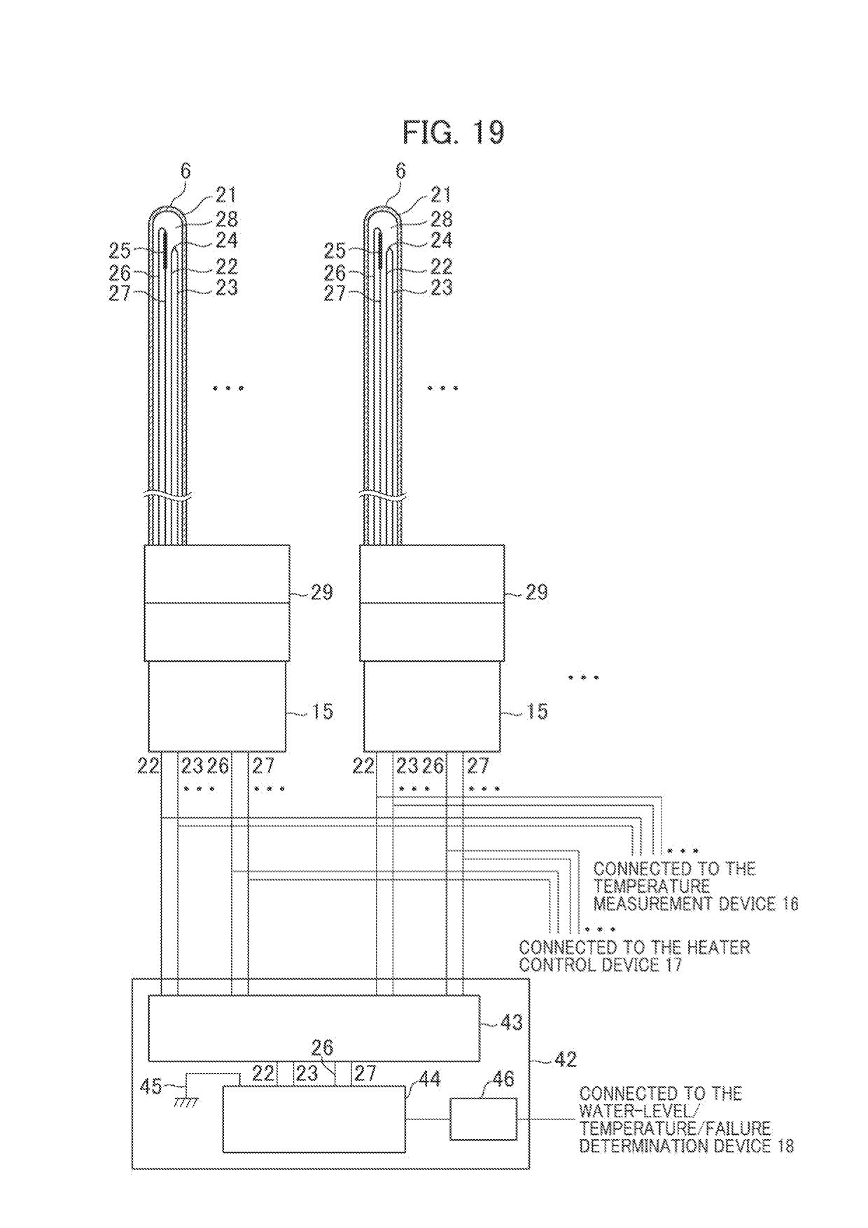

FIG. 18 is a conceptual diagram showing the system configuration of the fourth embodiment. In the case of the fourth embodiment, a resistance measurement device 42 is added to the configuration of the first embodiment. FIG. 19 is a diagram showing a detailed configuration of the resistance measurement device 42 according to the fourth embodiment. The thermocouple wires 22 and 23 as well as the heater lead wires 26 and 27 are drawn from the water-level/temperature detection sensor 6. The thermocouple wires 22 and 23 as well as the heater lead wires 26 and 27 branch from the signal and heater cables 15 connected to the temperature measurement device 16 and the heater control device 17, being connected to a change-over switch 43 provided inside the resistance measurement device 42. On the basis of a command received from the water-level/temperature/failure determination device 18, the change-over switch 43 selects one water-level/temperature detection sensor 6 from all the water-level/temperature detection sensors 6 and connects the selected water-level/temperature detection sensor 6 to a resistance meter 44. The resistance meter 44 measures all inter-terminal resistances of a total of 5 cables which are the thermocouple wires 22 and 23, the heater lead wires 26 and 27 as well as an earth wire 45. The resistance meter 44 supplies resistance data representing results of the measurements to the water-level/temperature/failure determination device 18 by way of a transmission device 46. The water-level/temperature/failure determination device 18 compares each resistance included in the data received from the resistance meter 44 with a threshold value determined in advance in order determine whether or not the water-level/temperature detection sensor 6 has failed.

The fourth embodiment has a merit that, when a water-level/temperature detection sensor 6 is determined to have failed because a small temperature increase is detected, the failure may have been caused by only a broken heater lead wire while the sound state of the thermocouple wire can be detected. That is to say, this embodiment also has a merit that the water-level/temperature detection sensor 6 can be used as a temperature meter, even in the case of heater-loop failure.

### Fifth Embodiment

In this embodiment, the reliability can be improved by identifying a position at which the in-core instrumentation tube 7 having the water-level/temperature detection sensor 6 embedded therein is inserted into the inside of the reactor.

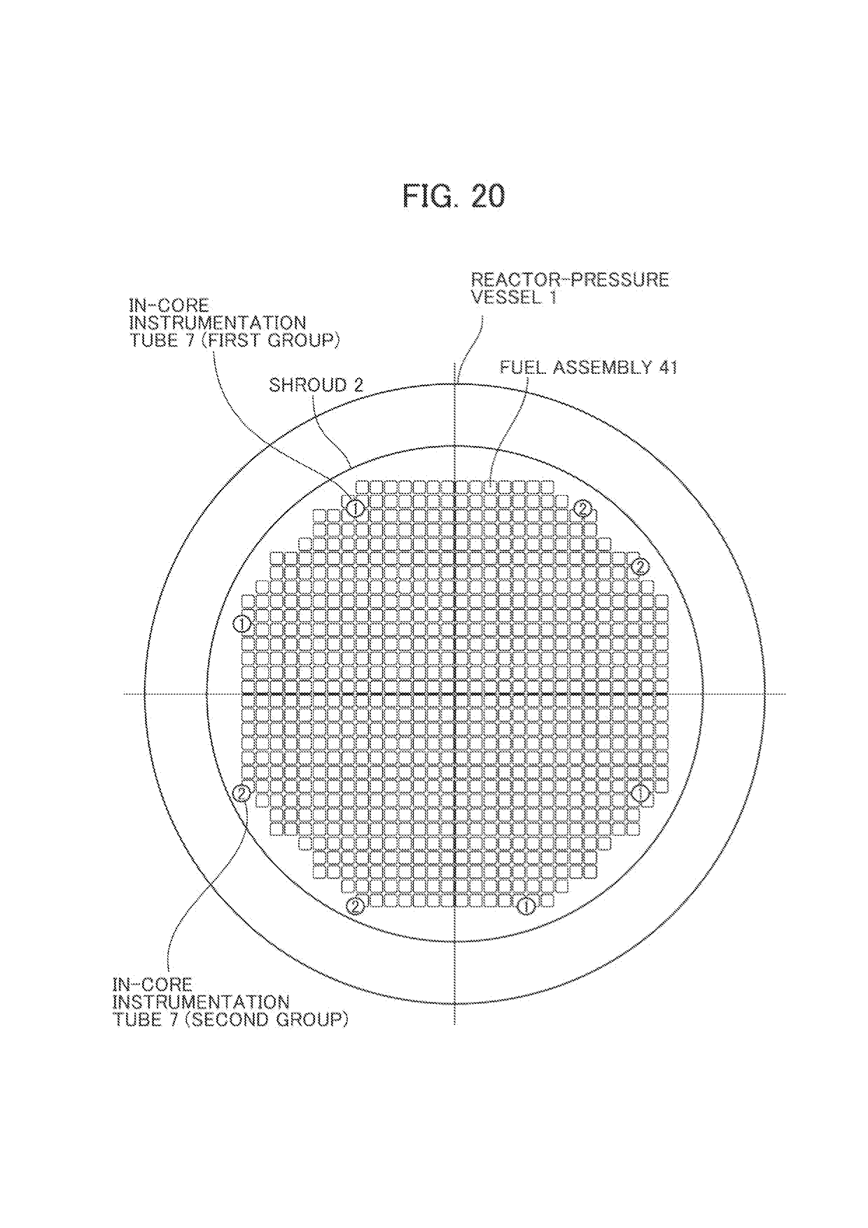

The entire system configuration of this embodiment is similar to the first embodiment. As shown in FIG. 20, however, the in-core instrumentation tube 7 having the water-level/temperature detection sensor 6 embedded therein is provided at a position adjacent to the outermost-circumference fuel of the reactor or a position outside the outermost-circumference fuel. In the reactor core 3 of the reactor, on the outermost-circumference fuel, the effect of the neutron leakage is big and a fuel with a low reactivity is normally placed. Thus, there is exhibited a characteristic showing that an output generated in the course of an operation is small and the amount of residual heat dissipated by the fuel after the scrum is relatively small in comparison with that of the center of the reactor core 3. So, the in-core instrumentation tube 7 is placed at such a position in order to make it relatively difficult for the temperature to increase in the neighborhood of the in-core instrumentation tube 7 in comparison with that at the center of the reactor core 3 even in the event of a situation in which the fuel is inadvertently exposed on the outside of the cooling water. Thus, it is possible to lengthen a period in which the measurement of a water level and temperatures can be carried out.

### Sixth Embodiment

A sixth embodiment is obtained by adding in-core instrumentation tubes 7 each having a water-level/temperature detection sensor 6 embedded therein to the configuration of the fifth embodiment. The additional in-core instrumentation tubes 7 are placed at the central and middle portions of the reactor core 3.

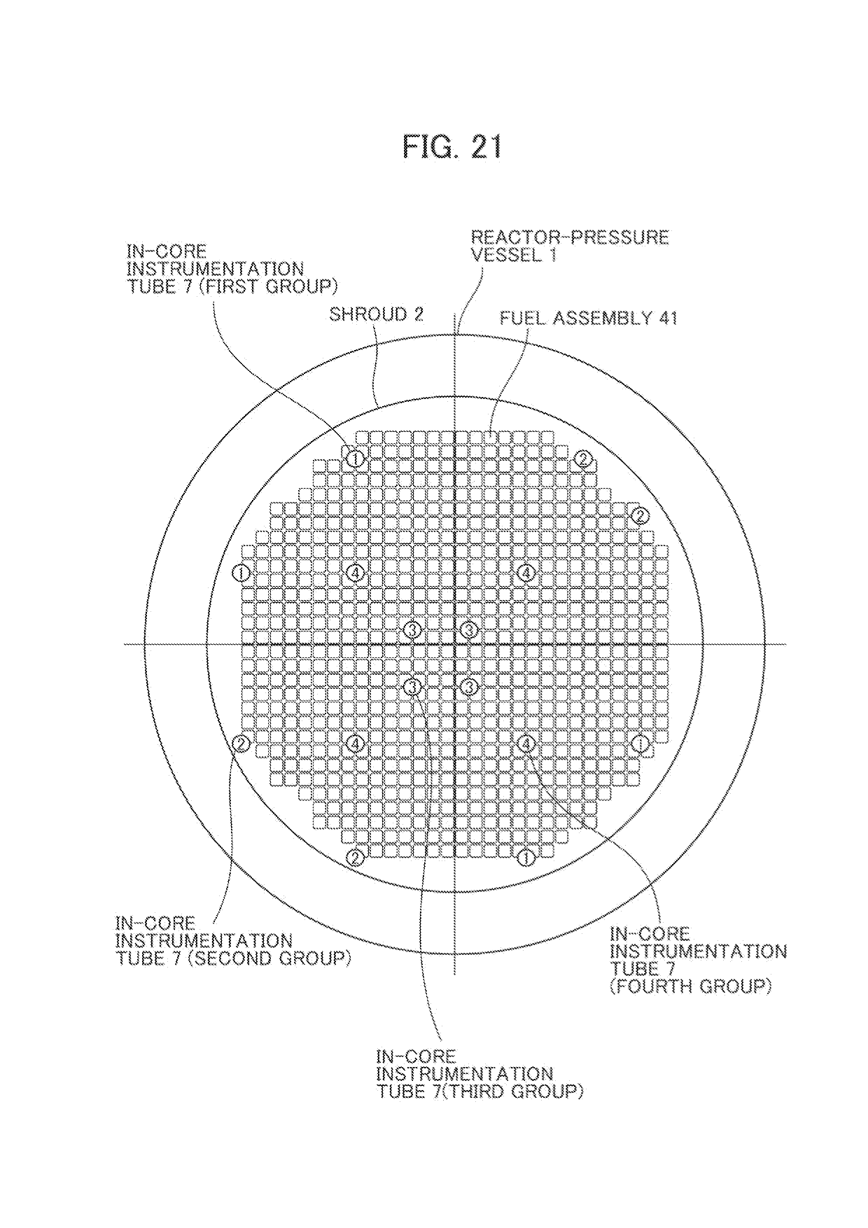

FIG. 21 shows the position of the in-core instrumentation tube 7 inside a reactor pressure vessel 1. As shown in FIG. 21, in addition to the in-core instrumentation tubes 7 placed on outer circumferences of the reactor core 3 to serve as tubes each having a water-level/temperature detection sensor 6 embedded therein, additional in-core instrumentation tubes 7 each having a water-level/temperature detection sensor 6 embedded therein are placed at the central and middle portions of the reactor core 3. In accordance with the layout of the in-core instrumentation tubes 7 placed as described above, temperature data measured for each water-level/temperature detection sensor 6 or information on a failing water-level/temperature detection sensor 6 is stored as time-series data/information so that it is possible to make sure of a temperature-distribution change and the progress of a sensor residual inside the reactor core 3.

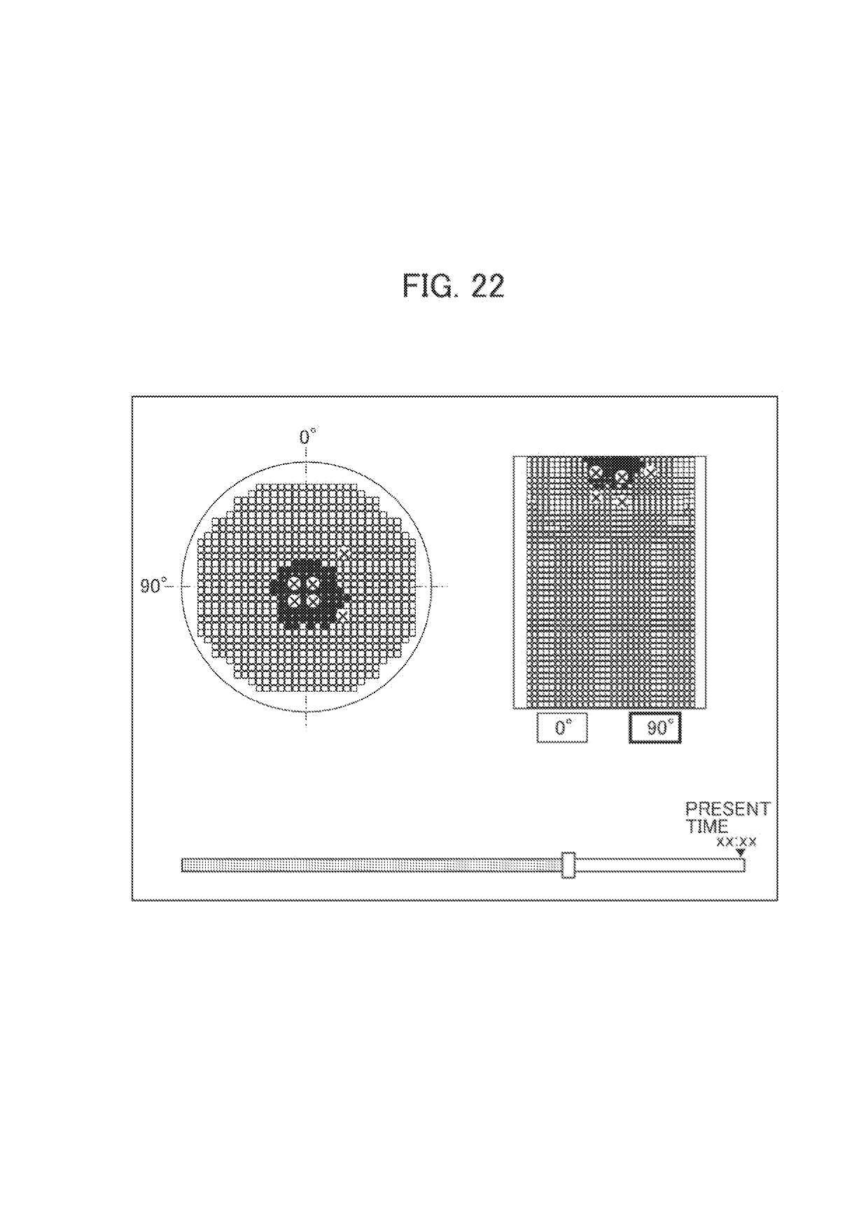

FIG. 22 is an explanatory diagram showing a typical display of a 3-dimensional temperature distribution inside the reactor pressure vessel 1 according to the sixth embodiment. The 3-dimensional distribution of temperatures is shown as a colored contour diagram and a failing sensor is indicated by a cross (X) mark. A horizontal rod shown at the bottom of the screen is a slide bar. When the operator moves a cursor along the slide bar to a position on the bar, the information displayed on the screen is changed to a temperature distribution and failing-sensor information which are generated for the position representing a past time.

As described above, in accordance with this embodiment, a typical display of a 3-dimensional temperature distribution and information on a failing sensor in the reactor can be visually examined. In addition, by displaying the changes of the distribution and the information with the lapse of time, it is possible to make sure of a temperature-distribution change and the progress of a sensor residual inside the reactor core 3.

What is claimed is:

1. A reactor water-level/temperature measurement apparatus for detecting a water level in a reactor on the basis of temperatures measured by making use of a plurality of thermocouples installed inside a reactor pressure vessel, the reactor water-level/temperature measurement apparatus comprising:
an in-core instrumentation housing welded to the bottom of the pressure vessel;
an in-core instrumentation guide tube placed between the upper portion of the in-core instrumentation housing and a reactor-core support plate;
an in-core instrumentation tube inserted into the in-core instrumentation housing and the in-core instrumentation guide tube;
a water-level/temperature detection sensor including one of the thermocouples and a heater wire, the thermocouples being installed at a plurality of vertical positions inside the in-core instrumentation tube;
a temperature measurement device for measuring the temperatures of the thermocouples;
a heater control device for controlling a current flowing to the heater wire;
a storage device used for storing a threshold-value table associating a temperature indicated by the thermocouple before a current flows to the heater wire and a temperature increase indicated by the thermocouple while a current is flowing to the heater wire with a steam atmosphere, a water atmosphere and a sensor failure;
a water-level/temperature/sensor-failure determination device for comparing a thermocouple temperature measured by the temperature measurement device before a current flows to the heater wire as well as a thermocouple temperature increase measured by the temperature measurement device while a current is flowing to the heater wire with the contents of the threshold-value table and for determining whether the environment of the water-level/temperature detection sensor is a steam atmosphere or a water atmosphere or for determining whether or not the water-level/temperature detection sensor has failed in order to generate information on reactor water levels, reactor temperatures and sensor failures on the basis of data representing determination results; and
a display device for displaying the information on reactor water levels, reactor temperatures and sensor failures.

2. The reactor water-level/temperature measurement apparatus according to claim 1,
wherein the reactor water-level/temperature measurement apparatus further includes a flow suppression structure for suppressing a coolant flow in a surrounding area of the water-level/temperature detection sensor.

3. The reactor water-level/temperature measurement apparatus according to claim 1, wherein:
the water-level/temperature/sensor-failure determination device holds a first current set value used for determining whether or not the environment of the water-level/temperature detection sensor is a steam atmosphere and a second current set value greater than the first current set value; and
only when the environment of the water-level/temperature detection sensor is determined to be not a steam atmosphere as a result of allowing a current having a magnitude equal to the first current set value to flow to the heater wire, a current having a magnitude equal to the second current set value is allowed to flow to the heater wire in order to determine whether the environment of the water-level/temperature detection sensor is a water atmosphere or the water-level/temperature detection sensor has failed.

4. The reactor water-level/temperature measurement apparatus according to claim 1, wherein:
the reactor water-level/temperature measurement apparatus further includes a resistance measurement device for measuring resistances between a thermocouple wire, a heater lead wire and an earth wire which are drawn from the water-level/temperature detection sensor;
the resistances measured by the resistance measurement device are compared with determination values held in the water-level/temperature/sensor-failure determination device in order to determine whether or not the water-level/temperature detection sensor has failed; and
a result of the determination as to whether or not the water-level/temperature detection sensor has failed is displayed.

5. The reactor water-level/temperature measurement apparatus according to claim 1, wherein the water-level/temperature detection sensors are provided in a plurality of the in-core instrumentation tubes at positions different in height from each other so that the installation heights of the water-level/temperature detection sensors can be used in interpolation (to find a water level).

6. The reactor water-level/temperature measurement apparatus according to claim 1,
wherein the reactor water-level/temperature measurement apparatus further includes a storage device used for storing a reactor water level, reactor temperatures and sensor-failure data as time-series information.

7. A reactor water-level/temperature measurement apparatus for detecting a water level in a reactor on the basis of temperatures measured by making use of a plurality of thermocouples installed inside a reactor pressure vessel, the reactor water-level/temperature measurement apparatus comprising:
an in-core instrumentation housing welded to the bottom of the pressure vessel;
an in-core instrumentation guide tube placed between the upper portion of the in-core instrumentation housing and a reactor-core support plate;
an in-core instrumentation tube inserted into the in-core instrumentation housing and the in-core instrumentation guide tube and placed at a location adjacent to an outermost-circumference fuel of the reactor or a location outside the outermost-circumference fuel;
a water-level/temperature detection sensor including one of the thermocouples installed at a plurality of vertical positions inside the in-core instrumentation tube;
a temperature measurement device for measuring the temperatures of the thermocouples;
a water-level/temperature/sensor-failure determination device for determining whether the environment of the water-level/temperature detection sensor is a steam atmosphere or a water atmosphere or for determining whether or not the water-level/temperature detection sensor has failed on the basis of the temperature of the thermocouple in order to generate information on reactor water levels, reactor temperatures and sensor failures on the basis of data representing determination results; and
a display device for displaying the information on reactor water levels, reactor temperatures and sensor failures.

8. The reactor water-level/temperature measurement apparatus according to claim 7 wherein:
in addition to the in-core instrumentation tube placed at a location adjacent to an outermost-circumference fuel of the reactor or a location outside the outermost-circumference fuel, an in-core instrumentation tube is placed at a location other than the location adjacent to the outermost-circumference fuel and the location outside the outermost-circumference fuel; and
the water-level/temperature detection sensors each including one of the thermocouples are installed at a plurality of vertical positions inside the in-core instrumentation tubes.

9. The reactor water-level/temperature measurement apparatus according to claim 8,
wherein the reactor water-level/temperature measurement apparatus further includes a storage device used for storing a reactor water level, reactor temperatures and sensor-failure data as time-series information.
